(19) United States
(12) Patent Application Publication
(10) Pub. No.: US 2003/0142159 A1
(43) Pub. Date: Jul. 31, 2003

(54) Estimating local ejection chamber temperature to improve printhead performance

(76) Inventors: Ronald A. Askeland, San Diego, CA (US); Matthew D. Giere, San Diego, CA (US); Satya Prakash, Poway, CA (US)

Correspondence Address: HEWLETT-PACKARD COMPANY, Intellectual Property Administration, P.O. Box 272400, Fort Collins, CO, 80527-2400, US

(21) Appl. No.: 10/066,529

(22) Filed: Jan. 31, 2002

(51) Int. Cl. B41J 29/38

(52) U.S. Cl. 347/14

(57) ABSTRACT

A temperature control system for an inkjet printhead assembly, including a printhead assembly having ink ejection elements energizable by an electrical pulse having an amplitude and pulse width, a sensor coupled to the printhead assembly for generating a signal representative of the printhead temperature, a memory for storing current printhead operating parameters and a controller for reading a nominal operating pulse width, the signal from the sensor and the printhead operating parameters, said controller calculates an adjusted pulse width using the nominal operating pulse width, the signal from the sensor and the current printhead operating parameters, wherein the controller uses the adjusted pulse width to control printhead temperature. A method of controlling the temperature of an inkjet printhead including providing a printhead assembly having ink ejection elements energizable by an electrical pulse having an amplitude and pulse width, reading a nominal printhead operating temperature and a nominal operating pulse width, obtaining current printhead operating parameters from a memory and a current printhead operating temperature using a sensor on the printhead, adjusting the pulse width based on the printhead operating parameters and the measured temperature of the printhead and applying the adjusted operating pulse width to the printhead to control printhead temperature.

### BACKGROUND OF THE INVENTION

Inkjet hardcopy devices print dots by ejecting very small drops of ink onto the print medium and typically include a movable carriage that supports one or more printheads each having ink ejecting ink ejection elements. The carriage traverses over the surface of the print medium, and the ink ejection elements are controlled to eject drops of ink at appropriate times pursuant to command of a microcomputer or other controller, wherein the timing of the application of the ink drops is intended to correspond to the pattern of pixels of the image being printed.

The typical inkjet printhead (i.e., the silicon substrate, structures built on the substrate, and connections to the substrate) uses liquid ink (i.e., dissolved colorants or pigments dispersed in a solvent). It has an array of precisely formed orifices or nozzles attached to a printhead substrate that incorporates an array of ink ejection chambers which receive liquid ink from the ink reservoir. Each chamber is located opposite the nozzle so ink can collect between it and the nozzle and has a ejection element located in the chamber. The ejection of ink droplets is typically under the control of a microprocessor, the signals of which are conveyed by electrical traces to the ejection element. When electric printing pulses heat the inkjet ejection chamber ejection element, a small portion of the ink next to it vaporizes and ejects a drop of ink from the printhead. Properly arranged nozzles form a dot matrix pattern. Properly sequencing the operation of each nozzle causes characters or images to be printed upon the paper as the printhead moves past the paper.

Thermal inkjet printheads require an electrical drive pulse from a printer in order to eject a drop of ink. The voltage amplitude, shape and width of the pulse affect the printhead's performance. It is desirable to operate the printhead using pulses that deliver a specified amount of energy. The energy delivered depends on the pulse characteristics (width, amplitude, shape), as well as the resistance of the printhead.

A thermal inkjet printhead requires a certain minimum energy to fire ink drops of the proper volume (herein called the turn-on energy). Turn-on energy can be different for different printhead designs, and in fact varies among different samples of a given printhead design as a result of manufacturing tolerances. In an integrated driver type printhead, the total resistance consists of the heater resistance in series with a field effect transistor and other trace resistances, each of which has an associated manufacturing tolerance. These tolerances add to the uncertainty in knowing how much energy is being delivered to any given printhead. Therefore, it is necessary to deliver more energy to the average printhead than is required to fire it (called “over-energy”) in order to allow for this uncertainty. As a result, thermal inkjet printers are configured to provide a fixed ink ejection energy that is greater than the expected lowest turn-on energy for the printhead cartridges it can accommodate. A consideration with utilizing a fixed ink ejection energy is that ejection energies excessively greater than the actual turn-on energy of a particular printhead cartridge result in a shorter operating lifetime for the ejection elements and degraded print quality.

One important factor in assuring high print quality of inkjet printers is control over the uniformity of ejected ink drops. Ink drop uniformity can be controlled by managing the temperature developed in the ejection elements of the printhead. Some scenarios that cause the ejection element to reach a temperature that is higher than that required to produce the correct sized ink drop include when the controller fires an ejection element at a high rate within a short period of time. Also, if the pulse width is longer than necessary, the temperature of the ejection element will be too high. If the temperature at the ejection element gets too high, gas bubbles will form and choke the nozzle. Also, at excessive temperatures, ink can decompose leaving residues on the surface of the ink ejection elements. These residues formed on the ink ejection elements can interfere with nucleation and drop formation, which can produce ink droplets with lower drop weight and lower velocity. In contrast, if the temperature is too low, the formation of ink drops will be poor leading to a decrease in image quality.

Thus, the energy applied to a ejection element affects performance, durability and efficiency. It is well known that the ejection energy must be above a certain ejection threshold to cause a vapor bubble to nucleate. Above this ejection threshold is a transitional range where increasing the ejection energy increases the volume of ink expelled. Above this transitional range, there is a higher optimal range where drop volumes do not increase with increasing ejection energy. In this optimal range drop volumes are stable even with moderate ejection energy variations. Since, variations in drop volume cause poor quality in printed output, it is in this optimal range that printing ideally takes place. As energy levels increase in this optimal range the printhead is prematurely aged due to excessive heating and ink residue build-up on the ejection elements.

In typical inkjet printers, as each droplet of ink is ejected from the printhead, some of the heat used to vaporize the ink driving the droplet is retained within the printhead and for high flow rates, conduction can heat the ink near the substrate. These actions can overheat the printhead, which can degrade print quality, cause the ink ejection elements to misfire, or can cause the printhead to stop ejecting completely. Printhead overheating compromises the inkjet printing process and limits high throughput printing. Consequently, it is difficult to efficiently control important thermal and energy aspects of the printhead.

Therefore, what is needed is a system and method to solve these problems.

### SUMMARY OF THE INVENTION

A temperature control system for an inkjet printhead assembly, including a printhead assembly having ink ejection elements energizable by an electrical pulse having an amplitude and pulse width, a sensor coupled to the printhead assembly for generating a signal representative of the printhead temperature, a memory for storing current printhead operating parameters and a controller for reading a nominal operating pulse width, the signal from the sensor and the printhead operating parameters, said controller calculates an adjusted pulse width using the nominal operating pulse width, the signal from the sensor and the current printhead operating parameters, wherein the controller uses the adjusted pulse width to control printhead temperature. A method of controlling the temperature of an inkjet printhead including providing a printhead assembly having ink ejection elements energizable by an electrical pulse having an amplitude and pulse width, reading a nominal printhead operating temperature and a nominal operating pulse width, obtaining current printhead operating parameters from a memory and a current printhead operating temperature using a sensor on the printhead, adjusting the pulse width based on the printhead operating parameters and the measured temperature of the printhead and applying the adjusted operating pulse width to the printhead to control printhead temperature.

### BRIEF DESCRIPTION OF THE DRAWINGS

The present invention can be further understood by reference to the following description and attached drawings that illustrate the preferred embodiment. Other features and advantages will be apparent from the following detailed description of the preferred embodiment, taken in conjunction with the accompanying drawings, which illustrate, by way of example, the principles of the invention.

FIG. 1 shows a block diagram of an overall printing system incorporating the present invention.

FIG. 2 is an exemplary printer that incorporates the present invention and is shown for illustrative purposes only.

FIG. 3 shows for illustrative purposes only a perspective view of an exemplary print cartridge incorporating the present invention.

FIG. 4 is a detailed view of the driver head of FIG. 3 showing the nozzle and primitive layout of the printhead assembly 116.

FIG. 5 shows actual thermal sense resistor temperature measurements and estimated local ejection chamber temperature.

FIG. 6 is a flowchart showing procedure used by the apparatus of FIG. 1.

### DETAILED DESCRIPTION OF A PREFERRED EMBODIMENT

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

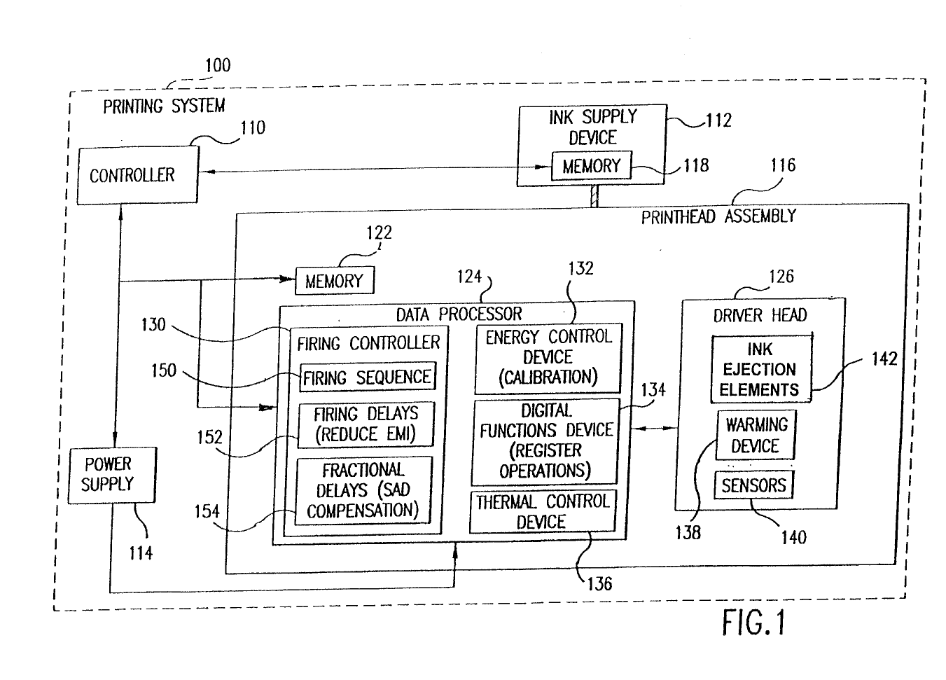

FIG. 1 shows a block diagram of an overall printing system incorporating the present invention. The printing system 100 can be used for printing a material, such as ink on a print medium. The printing system 100 can be coupled to a host system (not shown), which can be a computer or microprocessor for producing print data. The printing system 100 includes a controller 110 coupled to an ink supply device 112, a power supply 114 and a printhead assembly 116. The ink supply device 112 includes an ink supply memory device 118 and is fluidically coupled to the printhead assembly 116 for selectively providing ink to the printhead assembly 116. The printhead assembly 116 includes a printhead memory device 122, a data processor 124 and a driver head 126 which includes an array of inkjet ink ejection elements 142 for ejecting ink drops. The driver head 126 further includes temperature sensors 140 for dynamically measuring the printhead temperature. The temperature sensors 140 can be analog or digital sensors. Preferably the sensors 140 are distributed around the driver head so that both a point temperatures and a “global” temperature is sensed.

Printhead memory device 122 is used to store data regarding the operation of printhead 116 such as measured driver head 126 temperatures by temperature sensors 140; the ejection history of the ejection elements 142; the thermal response model of the driver head 126, the printhead assembly 116 and the print cartridge body 304; and the sensed amount of power supplied to the printhead assembly 116; and preprogrammed known optimal operating ranges, such as temperature and energy ranges.

During operation of the printing system 100, the power supply 114 and the controller 110 provide a controlled voltage to the printhead assembly 116. Also, the controller 110 receives the print data from the host system and processes the data into printer control information and image data. The processed data, image data and other static and dynamically generated data (discussed in detail below), is exchanged with the ink supply device 112 and the printhead assembly 116 for efficiently controlling the printing system.

The ink supply memory device 118 can store various ink supply specific data, including ink identification data, ink characterization data, ink usage data and the like. The ink supply data can be written and stored in the ink supply memory device 118 at the time the ink supply device 112 is manufactured or during operation of the printing system 100. Similarly, the printhead memory device 122 can store various printhead specific data, including printhead identification data, warranty data, printhead characterization data, printhead usage data, etc. This data can be written and stored in the printhead memory device 122 at the time the printhead assembly 116 is manufactured or during operation of the printing system 100.

The data processor 124 preferably includes digital circuitry and communicates via electrical signals with the controller 110, driver head 126 and various analog devices, such as temperature sensors 140 which can be located on the driver head 126. The controller 110 sends commands to the data processor 124 and receives and processes signals from the data processor 110 in a bi-directional manner. The bi-directional communication enables the data processor 124 to dynamically formulate and perform its own ejection and timing operations based on sensed and given operating information for regulating the temperature of, and the energy delivered to the printhead assembly 116.

These formulated decisions by controller 110 are preferably based on, among other things, sensed printhead temperatures, sensed amount of power supplied, real time tests, and preprogrammed known optimal operating ranges, such as temperature and energy ranges. As a result, the data processor 124 enables efficient operation of the driver head 126 and produces droplets of ink that are printed on a print media to form a desired pattern for generating enhanced printed outputs.

The data processor 124 further includes a firing controller 130, an energy control device 132, a digital function device 134 and a thermal control device 136. The driver head 126 includes a warming device 138 and temperature sensors 140. Although the firing controller 130, energy control device 132, digital function device 134, thermal control device 136, warming device 138 and temperature sensors 140 could be sub-components of other components, such as controller 110, in a preferred embodiment they are respective sub-components of the data processor 124 and the driver head 126.

The firing controller 130 communicates with the controller 110 and the driver head 126 for regulating the firing of ink ejection elements 142. The firing controller 130 includes a ejection sequence sub-controller 150 for selectively controlling the sequence of fire pulses, a firing delay sub-controller 152 for reducing electromagnetic interference in the printhead assembly 116 and a fractional delay sub-controller 154 for compensating for scan axis directionality errors of the driver head 126.

The energy control device 132 communicates with the controller 110 and the temperature sensors 140 of the driver head 126 for regulating the energy delivered to the driver head 126. Similarly, the thermal control device 136 communicates with the controller 110 and the temperature sensors 140 and the warming device 138 of the driver head 126 for regulating the thermal characteristics of the driver head 126. The thermal control device 136 accomplishes this by activating the warming device 138 when the temperature sensors 140 indicate that the driver head 126 is below a threshold temperature. In another embodiment, energy and thermal control devices 132, 136 also communicate with the printhead assembly memory device 122. The digital functions device 134 manages internal register operations and processing tasks of the data processor 124.

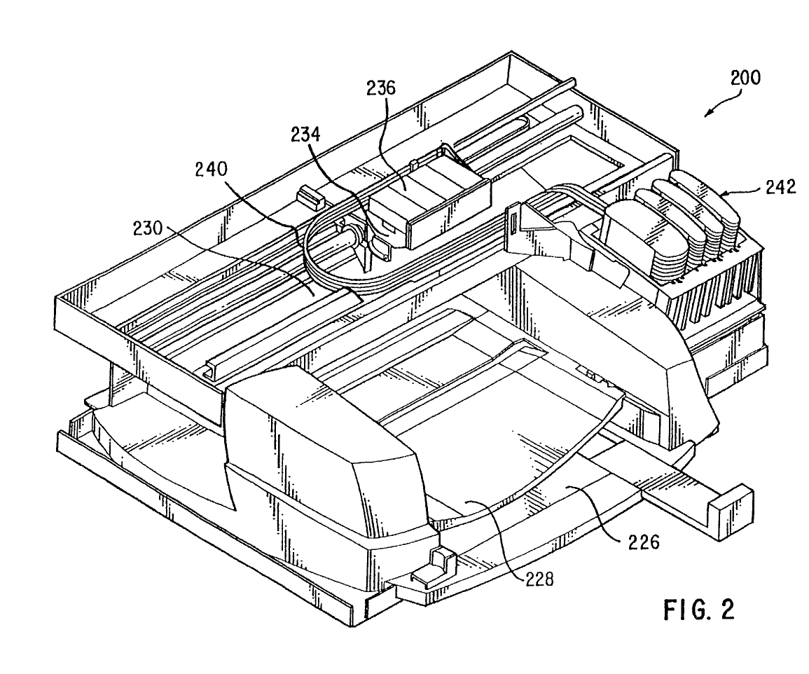

FIG. 2 is an exemplary high-speed printer 200 that can incorporate the printing system 100 of FIG. 1. Printer 200 includes a tray 226 for holding print media. When a printing operation is initiated a print media is fed into printer 200 from tray 226. The sheet then brought around in a U direction and travels in an opposite direction toward output tray 228. Other paper paths, such as a straight paper path, can also be used. The sheet is stopped in a print zone 230, and a scanning carriage 234, supporting one or more print cartridges 236, is then scanned across the sheet for printing a swath of ink thereon. After a single scan or multiple scans, the sheet is then incrementally shifted using feed rollers to a next position within the print zone 230. Carriage 234 again scans across the sheet for printing a next swath of ink. The process repeats until the entire sheet has been printed, at which point it is ejected into output tray 228. The print cartridges 236 can be removably mounted or permanently mounted to the scanning carriage 234. Each print cartridge 236 is fluidically coupled, via a flexible conduit 240, to one of a plurality of fixed or removable ink containers 242. Alternatively, the print cartridges 236 can have self-contained ink reservoirs.

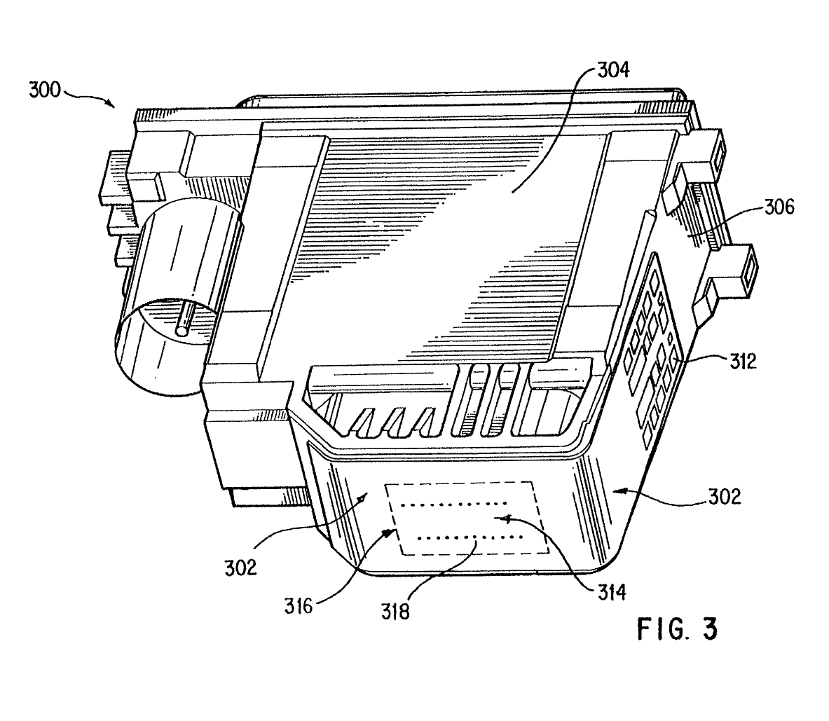

FIG. 3 shows a perspective view of an exemplary print cartridge assembly 300 which can incorporate the present invention. The print cartridge 300 contains a printhead assembly 302 (an example of the printhead assembly 116 of FIG. 1), a print cartridge body 304 and a print cartridge memory device 306 (an example of memory device 118). The printhead assembly 302 contains a data processor 314 (an example of the data processor 124 of FIG. 1) integrated with a driver head 316 (an example of driver head 126 of FIG. 1). The driver head 316 preferably contains a plurality of ink ejection elements (an example of ink ejection elements 142 of FIG. 1) and ink ejection chambers (not shown) each associated with the ink ejection elements and located behind nozzles 318. The printhead assembly 302 further includes interconnect contact pads 312. The contact pads 312 align with and electrically contact electrodes (not shown) on carriage 234 of FIG. 3 to receive signals from controller 110.

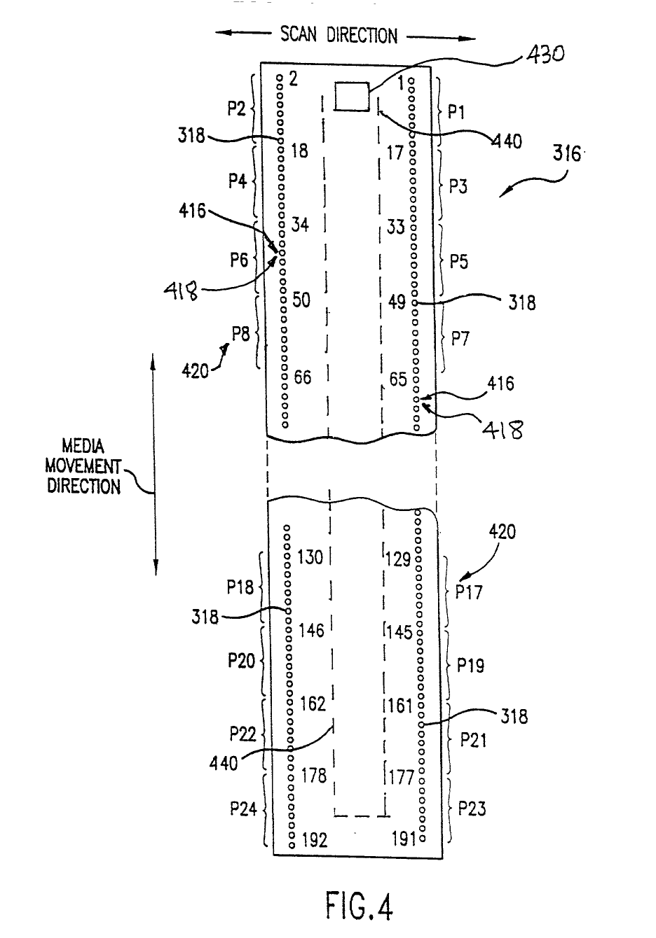

FIG. 4 is a detailed outside view of the printhead assembly 302 of FIG. 3. The elements of FIG. 4 are not to scale and are exaggerated for simplification. Conductors (not shown) are formed on the back of printhead assembly 302 and terminate in contact pads 312 for contacting electrodes on carriage 234. The electrodes on carriage 234 are coupled to the controller 110 and power supply 114 for providing communication with the printhead assembly 302. The other ends of the conductors are bonded to the printhead assembly via electrodes. The printhead assembly 302 has ink ejection elements 416 (an example of the ink ejection elements 142 of FIG. 1) located behind the nozzles 318 and electrically coupled to the conductors. The controller 110 and data processor 124 provide the ink ejection elements 416 with operational electrical signals.

Also shown is a digital temperature sensor (DTS) 430 and a thermal sense resistor (TSR) 440 used to measure the temperature of the driver head 316 (an example of temperature sensors 140 of FIG. 1). The TSR is used to gauge temperature changes by measuring its resistance. Since the thermal coefficient of resistance is known, the average temperature of the ejection element can be calculated. When any section of the TSR changes temperature, its resistivity changes. The resistance of the TSR is thus a function of the temperature of every constituent segment and measures the global temperature of the driver head 316.

The printhead assembly 302 has a barrier layer (not shown) defining ink ejection chambers. The ink ejection chambers (not shown) each contain an ink ejection element 416. The ink ejection chambers and ink ejection elements are located behind a single nozzle 318 of the driver head 316. For further details regarding the substrate, the barrier layer, ink ejection chambers and ink ejection elements; see U.S. Pat. No. 6,193,347, entitled “Hybrid Multi-Drop/Multi-Pass Printing System” which is herein incorporated by reference.

Each ink ejection element 416 ejects ink when selectively energized by the controller 110. The ink ejection elements 416 may be ejection elements or piezoelectric elements. Each ink ejection element 416 is allocated to a specific group of ink ejection elements, hereinafter referred to as a primitive 420. The printhead assembly 302 may be arranged into any number of multiple subsections with each subsection having a particular number of primitives containing a particular number of ink ejection elements 416. In the case of FIG. 4, the printhead assembly 302 has 192 firing ink ejection elements 416 with 192 associated nozzles 318. There are preferably 24 primitives in two columns of 12 primitives each. The primitives in each column have 8 ejection elements each for a total of 192 ejection elements.

In order to provide a printhead assembly where the ink ejection elements 416 are individually addressable, but with a limited number of lines between the printer 200 and print cartridge 236, the interconnections to the ink ejection elements 416 in an integrated drive printhead are multiplexed. The print driver circuitry comprises an array of primitive lines, primitive commons, and address select lines to control ink ejections elements 416. Specifying an address line and a primitive line uniquely identifies one particular ink ejection element 416.

Each ink ejection element 416 is controlled by its own drive transistor which shares its control input address select with the number of ejection elements 416 in a primitive. Each ink ejection element 416 is tied to other ink ejection elements 416 by a common node primitive select. Consequently, firing a particular ink ejection element 416 requires applying a control voltage at its address select terminal and an electrical power source at its primitive select terminal. To provide uniform energy per ink ejection element 416 only one ink ejection element is energized at a time per primitive. Where a primitive select interconnection and an address select line for a ink ejection element 416 are both active simultaneously, that particular heater ink ejection element 416 is energized. Only one address select line is enabled at one time. This ensures that the primitive select and group return lines supply current to at most one ink ejection element 416 at a time. Otherwise, the energy delivered to a heater ink ejection element 416 would be a function of the number of ink ejection elements 416 being energized at the same time.

Additional details regarding the architecture and control of inkjet printheads are described in U.S. Pat. No. 6,315,381 B1, entitled Energy Control Method for an Inkjet Print Cartridge;” U.S. Pat. No. 6,302,507 B1, entitled “Method for Controlling the Over-energy Applied To an Inkjet Print Cartridge Using Dynamic Pulse Width Adjustment Based on Printhead Temperature;” U.S. patent application Ser. No. 09/253,417, filed Feb. 19, 1999, entitled “A System and Method for Controlling Thermal Characteristics of an Inkjet Printhead;” and U.S. Pat. No. 6,193,347, entitled “Hybrid Multi-Drop/Multi-Pass Printing System.” The foregoing commonly assigned patents and patent applications are herein incorporated by reference.

During operation of the printing system 100, the power supply 114 provides a controlled voltage or voltages to the printer controller 110 and the printhead assembly 116. The data processor 124 determines the proper operating energy levels for the printhead assembly. Several components and systems within the printhead assembly have a minimum operating as well as a maximum operating temperatures and voltages, and the data processor helps to maintain the printhead assembly within these boundaries. Maximum operating temperatures are established assure printhead reliability and avoid print quality defects. Similarly, maximum power supply voltages are established to maximize printhead life.

One type of energy level determination is the determination of the operating voltage of the printhead assembly. Thus, it is important that the power supply voltage be adjustable in the printer. The optimal operating voltage is determined by first finding the turn-on energy of the printhead assembly. The turn-on energy is the amount of energy that is just adequate to cause drop ejection from the nozzles of the printhead assembly. This turn-on energy together with an over-energy margin is then used to find the operating voltage and this voltage is written to the printhead assembly memory device.

The optimal operating voltage is adjusted so as to achieve an energy level approximately 20% over the turn-on energy. This energy level is given by:

Energy=power*time

where the pulse width of the fire pulse is the measure of time. The power is given by:

power=V/r

where r=resistance of the printhead assembly and V=operating voltage.

For details on methods to determine the operating energy for a print cartridge, see U.S. Pat. No. 6,315,381 B1, entitled “Energy Control Method for an Inkjet Print Cartridge;” U.S. patent application Ser. No. 09/253,411, filed Feb. 19, 1999, entitled “A High Performance Printing System and Protocol;” U.S. Pat. No. 6,183,056, entitled “Thermal Ink Jet Print Head and Printer Energy Control Apparatus and Method,” U.S. Pat. No. 5,418,558, entitled “Determining the Operating Energy of a Thermal Ink Jet Printhead Using an Onboard Thermal Sense Resistor;” U.S. Pat. No. 5,428,376, entitled “Thermal Turn-on Energy Test for an Inkjet Printer;” and U.S. Pat. No. 5,682,185 entitled “Energy Management Scheme for an Ink Jet Printer.” The foregoing commonly assigned patents and patent applications are herein incorporated by reference.

Firing an inkjet printhead continuously at high frequency and heavy duty can cause the printhead to shutdown and stop firing after a few pages depending upon the firing voltage (over-energy). The cause of the problem is due to the global substrate 410 temperature rising to 60-85 degrees C. from the normal operating temperature of approximately 45 degrees C. At these elevated global substrate temperatures the local ink ejection element 416 area may be so hot (greater than 100 degrees C.) that the generated bubble never collapses which stops ink drop ejection and leads to further heating and thermal runaway. In the past the only solutions to the thermal problems caused by the excessive heating of the printhead have been to slow down printing or by controlling the over-energy to the driver head 126 by using dynamic pulse width adjustment. See, U.S. Pat. No. 6,302,507 B1, entitled “Method for Controlling the Over-energy Applied To an Inkjet Print Cartridge Using Dynamic Pulse Width Adjustment Based on Printhead Temperature.” This slow down is accomplished by using more passes or by reducing the swath height (i.e., using less ejection elements) of the driver head.

Present printer thermal control of the driver head 126 is purely sensor based: trickle warming, dynamic pulse width adjustment, swath cutting, and other thermal control techniques are applied solely based on the output of temperature sensors 140. The efficiency of thermal control can be improved by intelligent use of information regarding how the driver head 126 is firing its ejectors. The present invention improves dynamic pulse width adjustment by incorporating the use of ejection history information in conjunction with temperature measurements.

Current temperature estimates are based solely on the TSR 440, the DTS 430 or a combination thereof. However, the temperature that is most relevant to printhead operation is the local ejection element 416/ejection chamber temperature 418. Referring to FIG. 4, due to layout issues on the driver head 316 it is typically not feasible to locate the TSR 440 or DTS 430 close to the ejection elements 416. As a consequence, there are differences in the local temperature in ejection chambers 418 and the global temperature measured by the TSR 440. The temperature difference is due to the fact that since the driver head 316 does not typically operate in a continuous state, there are thermal transients that affect the TSR 440 and ejection elements 416 differently. The ejection elements 416 are located along the edges of the long side of the driver head 316. The TSR 440 is routed approximately 500 μm inboard of the ejection elements 416. Heat must flow from the ejection elements 416 to the TSR before it can be measured. The time required for this heat to flow to the TSR where it can be measured creates a latency in the control system. As a consequence there is an inherent minimum period of time required to respond to changes in operation. Thus, the temperature used to make pulse width decisions is often not current.

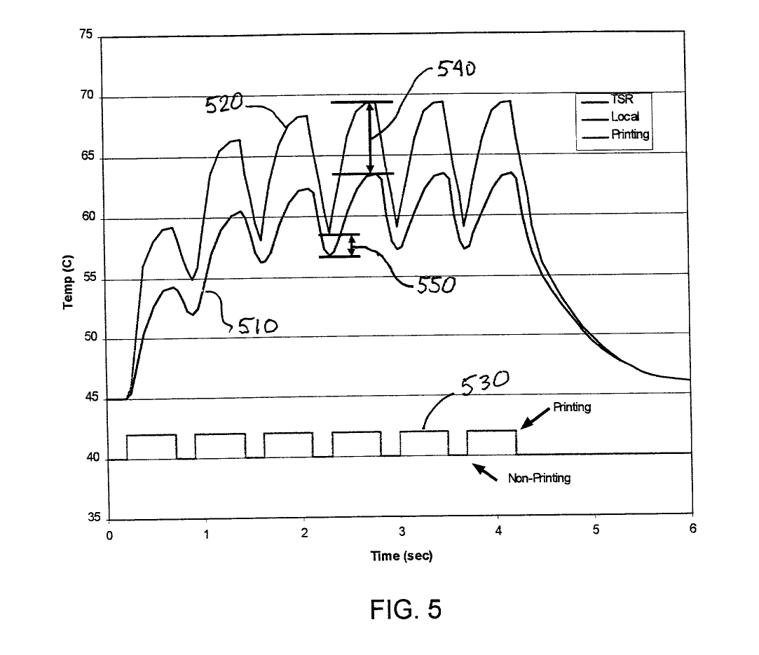

The relationship between the TSR 440 or DTS 430 temperature and the ejection chamber temperature varies depending on the ejection history of the driver head 316. FIG. 5 shows actual TRS temperature measurements 510 and the estimated local ejection chamber temperature 520 over six swaths of printing 530. The latency associated with using the TSR or DTS to predict ejection chamber temperatures is evident in FIG. 5 because the TSR 440 temperature rises slowly relative to the local ejection chamber temperature 520 of the driver head 316 while printing and the TSR temperature 510 lowers slowly relative to the local ejection chamber temperature 520 drops off abruptly when printing stops. Thus, even a very short break in printing can rapidly change the ejection chamber temperature 520 without substantially affecting the TSR temperature 510.

During periods of rapid printing, i.e., rapid heating, latency in the TSR 440 temperature measurement causes the temperature of the ejection chamber to be underestimated 540 more than when not printing 550. This reduces the effectiveness of dynamic pulse width adjustment and can drive the temperature of the ejection chambers 418 above acceptable limits. When a driver head 316 stops printing, the ejection chambers 418 cool faster than the TSR 440. As a consequence, low density printing (i.e., low ejection rates) in the wake a high density printing can be adversely affected because dynamic pulse width adjustment reduces the pulse width based on the measured TSR temperature, since it is known that the turn-on energy of a ejection element is reduced when the driver head 316 is hot. Since the ejection chamber 418 region cools faster than the TSR, in the wake of a high density printing region, the TSR temperature reads higher than the ejection chamber 418. When dynamic pulse width adjustment is used, this can result in over-reducing the pulse which results in ejection elements 416 that do not eject drops.

These inaccurate estimates of the local ejection chamber temperatures cause the printer to slow down more than needed and/or allow the driver head 316 to get too hot. The present invention can be used to maximize throughput by slowing down the printer less by more accurately estimating the local ejection chamber temperature. The present invention provides more accurate estimates of the local ejection chamber temperature by combining the ejection history of the driver head 316 with TSR 440 and/or DTS 430 temperature measurements. This provides a more relevant temperature estimate that can be used to control dynamic pulse width adjustment.

The system maintains and controls the printhead assembly temperature at the desired optimum temperature by using digital feedback of printing system parameters such as such as measured driver head 126 temperatures by temperature sensors 140; the ejection history of the ejection elements 142; the thermal response model of the driver head 126; the thermal response model of the print cartridge body 304; the sensed amount of power supplied to the printhead assembly 116; and preprogrammed known optimal operating ranges, such as temperature and energy ranges.

The ejection history of the ejection elements 142 or groups of ejection elements can be used in conjunction with the temperature sensors 140 to better estimate the true temperature of different regions of the driver head 126. When the driver head 126 is printing, the temperature sensors 140 will always heat more slowly than the ejection chambers and read a temperature that is lower than the temperature of the ejection chambers. Likewise, when the driver head 126 stops firing, the TSR temperature drops more slowly that the ejection chamber temperature and thus reads artificially high. Even a derivative control scheme used to predict future conditions, can only function once the trend propagates to the temperature sensors 140 and this requires the printing system to operate conservatively. However, since the primary source of heat in a driver head 126 is the firing of ejection elements, a thermal control algorithm is used that has one set of parameters when the driver head 126 has been printing, and thus being heated, and another set of parameters when the driver head 126 has not printing. Since the printing state can be captured instantaneously from the data stream to the driver head 126 and printhead assembly memory 122, the latency associated with temperature measurement can be avoided and the printing system can respond more quickly. Maintaining a ejection history of small groups of ejection elements 142 and using that ejection history in conjunction with the temperature sensors 140 creates a running estimate of the actual temperature distribution across the driver head 126, thus allowing optimized energy delivery to each ejection element 142.

Since the ejection rate of the driver head 126, and thus the energy put into the driver head 126, is known, the temperature sensors 140 can be used to estimate the temperature of the print cartridge body 304. This can be accomplished either by inferring the heat transfer to the print cartridge body 304 from either the slope of temperature gradients or from steady state conditions in continuous operation; when the print cartridge body 304 is hot, the driver head 126 will heat more quickly and cool more slowly. Likewise, if the print cartridge body 304 is hot, the driver head 126 will reach a higher steady state temperature for given ejection conditions than when the print cartridge body 304 is cold.

In accordance with the present invention, the controller 110 of the printing system or the data processor 124 make decisions and actions based on its input signals. For example, controlling, ejection, timing and pulse width decisions are made by the controller 110 or data processor 124. The thermal control device 136 receives a temperature from temperature sensors 140 of the driver head 126 and generates a digital command proportional to this sensed temperature. The controller 110 or data processor 124 analyzes the digital feedback of printing system parameters such as such as measured driver head temperatures by temperature sensors 140; the ejection history of the ejection elements 142; the thermal response model of the driver head 126, the thermal response model of the print cartridge body 304; the sensed amount of power supplied to the printhead assembly 116; and preprogrammed known optimal operating ranges, such as temperature and energy ranges and make control decisions based on the analysis. Using the printing system parameters, the controller 110 or data processor 124 determines whether the printing operation will keep the temperature of the driver head 126 within an acceptable temperature range. If not, then the nominal pulse width is adjusted to a suitable pulse width based on the sensed temperature. The controller 110 or data processor 124 can then calculate an adjusted pulse width from the nominal pulse width for the print cartridge using a pulse width adjustment factor. The pulse width adjustment factor is determined using the printing system parameters discussed above.

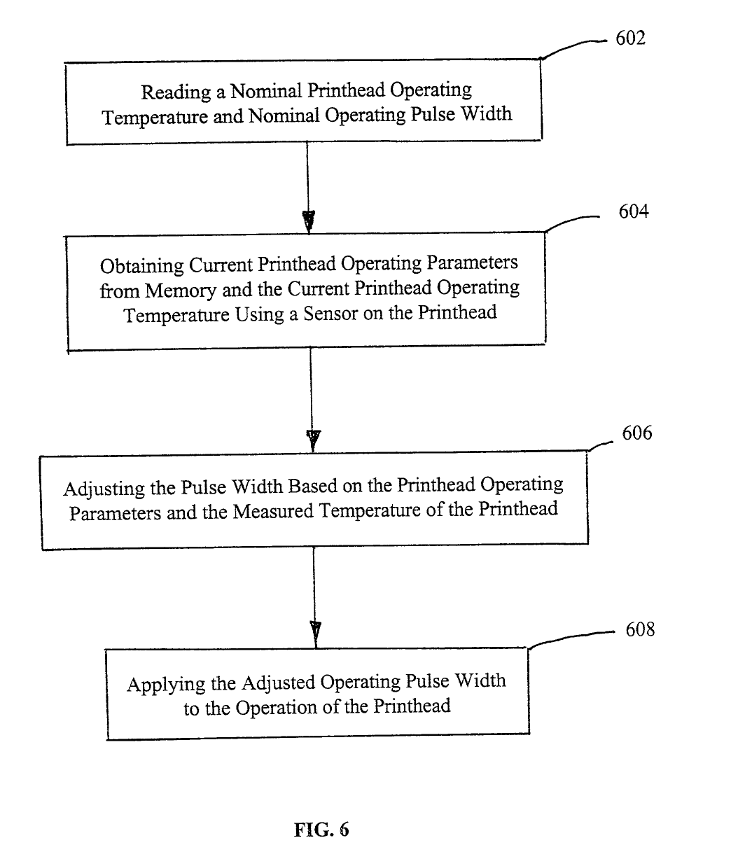

FIG. 6 is a flowchart showing procedure used by the present invention. In step 602, the nominal printhead operating temperature and the nominal operating pulse width are read from the printhead or printer memory. Step 602 is performed at start-up or when a print cartridge is replaced in the printer. In step 604, the current printhead operating parameters are obtained from memory and the current printhead operating temperature is obtained using a sensor on the printhead. In step 606, an adjusted operating pulse width is calculated based on the printhead operating parameters and the measured temperature of the printhead. In step 608 the adjusted operating pulse width is applied to the operation of the printhead. In a preferred embodiment, steps 604 to 608 are repeated continuously during printing in order to dynamically control the pulse width. Alternatively, steps 604-608 can be performed only at the beginning of a swath. The foregoing procedure is performed simultaneously and independently for each print cartridge. Either the he controller 110 or data processor 124 can perform the steps 602 to 608.

The adjustment of the pulse width of the present invention is based on measured driver head 126 temperatures and a thermal response model of the driver head 126, the printhead assembly 116 and the print cartridge 300 and on the ejection history of the ejection elements 142. The corrected pulse width is a function of nominal pulse width and the adjustment or calibration factor.

The present invention controls the pulse width to the driver head 126 at the beginning of each swath, or continuously during the swaths, based on the driver head temperature measured by sensors 140; the thermal response model of the driver head 126, printhead assembly 116, and print cartridge body 304; the ink temperature in the reservoir; and the ejection history of the ejection elements 142.

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. A temperature control system for an inkjet printhead assembly, comprising:
a printhead assembly having ink ejection elements energizable by an electrical pulse having an amplitude and pulse width;
a sensor coupled to the printhead assembly for generating a signal representative of the printhead temperature;
a memory for storing current printhead operating parameters; and
a controller for reading a nominal operating pulse width, the signal from the sensor and the printhead operating parameters, said controller calculates an adjusted pulse width using the nominal operating pulse width, the signal from the sensor and the current printhead operating parameters;
wherein the controller uses the adjusted pulse width to control printhead temperature.

2. A method of controlling the temperature of an inkjet printhead comprising:
providing a printhead assembly having ink ejection elements energizable by an electrical pulse having an amplitude and pulse width;
reading a nominal printhead operating temperature and a nominal operating pulse width;
obtaining current printhead operating parameters from a memory and a current printhead operating temperature using a sensor on the printhead;
adjusting the pulse width based on the printhead operating parameters and the measured temperature of the printhead; and
applying the adjusted operating pulse width to the printhead to control printhead temperature.
